(19) United States
(12) Patent Application Publication
(10) Pub. No.: US 2015/0319469 A1
(43) Pub. Date: Nov. 5, 2015

(54) DISTRIBUTION MANAGEMENT OF LICENSED CONTENT

(71) Applicant: Verizon Patent and Lincensing Inc., Arlington, VA (US)

(72) Inventors: Hans Raj Nahata, New Providence, NJ (US); Ravi Potluri, Coppell, TX (US); Sachinder D. Reddy, Allen, TX (US); Kaiss K. Alahmady, Richardson, TX (US)

(73) Assignee: VERIZON PATENT AND LICENSING INC., Arlington, VA (US)

(21) Appl. No.: 14/269,883

(22) Filed: May 5, 2014

(51) Int. Cl. H04N 21/258; H04N 21/45; H04N 21/437; H04N 21/24; H04N 21/239

(52) U.S. Cl. CPC H04N 21/25891; H04N 21/2407; H04N 21/2396; H04N 21/437; H04N 21/4532

(57) ABSTRACT

Techniques described herein may be used to selectively activate licensed content provided to customers. The licensed content may be activated for customers that have shown an interest in the content. Customers who are determined to not be likely to be interested in the content may have the channel automatically deactivated. In one implementation, a method may include activating licensed content associated with a user premises; obtaining usage statistics relating to viewing of the licensed content associated with the user premises; deactivating the licensed content, the deactivation being performed based on an analysis of the usage statistics; receiving a request to activate the licensed content; and automatically re-activating, in response to the received request, the licensed content.

### BACKGROUND

Content providers, such as television content providers, may provide a number of television channels to customers. The content providers may obtain the television channels from content producers (e.g., television studios, sports leagues, movie studios, etc.) and may compensate the content producers based on various contractual obligations agreed to with the content producers. In particular, for some television channels, the content provider may be obligated to pay the corresponding content producers based on a number of customers for which the channel is activated.

From the customer's perspective, an active channel may be a channel that, when the customer navigates (e.g., tunes or selects) a set-top box or television to the channel, the channel is presented to the customer. For channels that are not activated, the content provider may still allow the customer to navigate to the channel, but may display a message indicating that the channel is not currently active. The customer may be given directions on how to activate the channel. For example, the customer may select a “subscribe” option to activate the channel and to potentially begin being charged for the channel.

### BRIEF DESCRIPTION OF THE DRAWINGS

FIGS. 1A and 1B are diagrams illustrating an example of an overview of concepts described herein;

FIG. 2 is a diagram of an example environment in which systems and/or methods described herein may be implemented;

FIG. 3 is a diagram illustrating a data structure that may be maintained by a content provider;

FIG. 4 is a flow chart illustrating an example process for optimizing a set of customers for which content is active;

FIG. 5 is a flow chart illustrating an example process for activating or reactivating a television channel;

FIGS. 6A and 6B are diagrams illustrating example interfaces, respectively, that may be displayed to users at user premises;

FIG. 7 is a flow diagram illustrating one example relating to distribution management of content using the techniques described previously; and

FIG. 8 is a diagram of example components of a device.

### DETAILED DESCRIPTION OF PREFERRED EMBODIMENTS

The following detailed description refers to the accompanying drawings. The same reference numbers in different drawings may identify the same or similar elements.

Techniques described herein may be used to optimize the customers, in a set of customers, for which licensed content (e.g., a television channel) is active. In one implementation, a television channel may be activated for customers that have shown an interest in the channel. Customers that are determined to not be likely to be interested in the channel may have the channel automatically deactivated, potentially even when the customer is eligible to receive the channel without additional charges. If such a customer navigates to the deactivated channel, the customer may be given an option to activate the channel (e.g., through an automated on-screen “activate” option).

As described herein, the term “activate,” as applied to a particular television channel or other licensed content, may refer to provisioning the television channel or other licensed content so that a customer may receive the content through normal operation of a content viewing device (e.g., an active television channel, when selected through a set-top box, may immediately begin to be played back to the customer). The term “deactivate” may correspondingly refer to provisioning the content so that the customer is not eligible to obtain the content without first performing an act to activate the content with the content provider. Additionally, although media content, that is provided to a customer, will be generally discussed herein as television programming, in general, the media content can include any content (e.g., audio content, television content, other content) that is licensed by the content provider (“licensed content”).

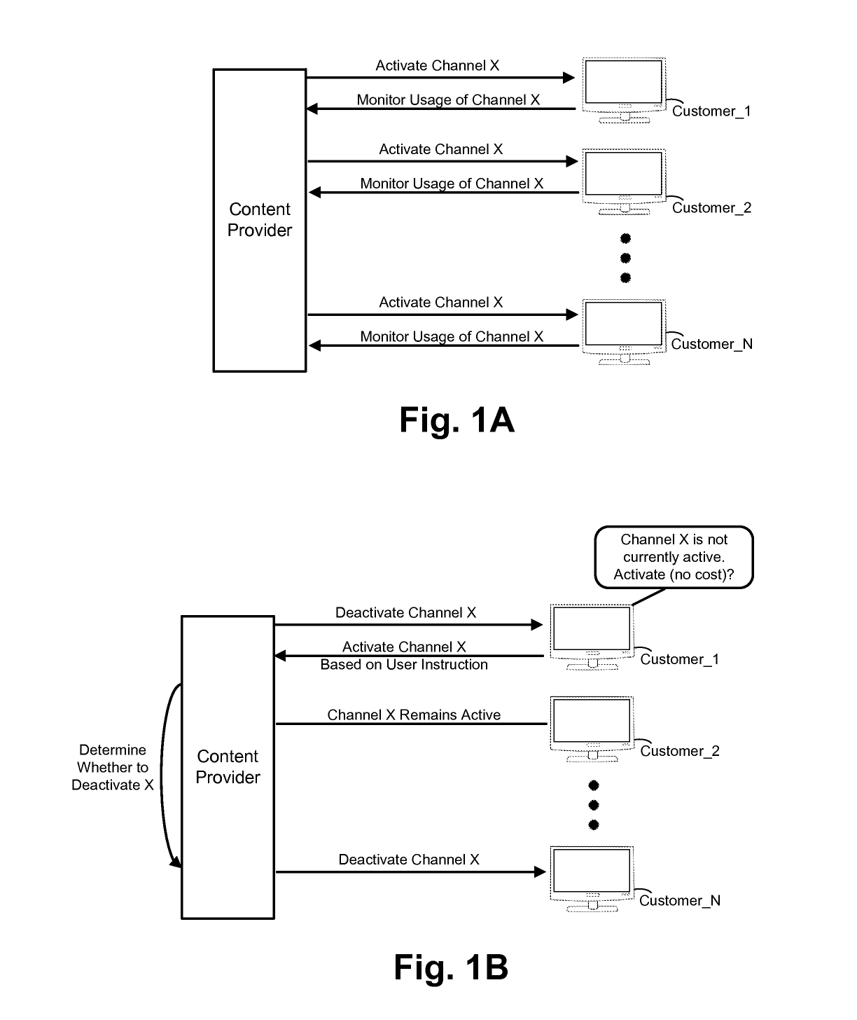

FIGS. 1A and 1B are diagrams illustrating an example of an overview of concepts described herein. In FIGS. 1A and 1B, a content provider (e.g., a television provider) may provide television content to a number of customers, each graphically represented by a television.

In FIG. 1A, assume the content provider activates a particular television channel (“Channel X”) for a number of customers (N customers) (“Activate Channel X”). The customers may include, for example, new customers of the content provider or customers that have recently signed up for a particular television package that includes channel X. The content provider may monitor usage statistics, for each of the customers, for a period of time (“Monitor Usage of Channel X”). For example, the content provider may monitor usage statistics, for a week or a month, relating to how many times each customer tunes a set-top box to channel X and/or the total amount of viewing time that each customer spends viewing channel X.

Referring to FIG. 1B, the content provider may, based on the monitored usage statistics, make decisions on whether to deactivate channel X (“Determine Whether to Deactivate X”). As an example, channel X may be deactivated for any of the monitored customers that, over the monitoring period, have not tuned to channel X. In this example, assume that the content provider determines that channel X should be deactivated for “Customer_{—}1” and “Customer_N” (“Deactivate Channel X”). “Customer_{—}2,” however, may have viewed channel X one or more times over the monitoring period, which may indicate that the customer is interested in channel X. Channel X may thus not be deactivated for Customer_{—}2 (“Channel X Remains Active”).

At some point after deactivation of channel X for Customer_{—}1, assume that Customer_{—}1 attempts to view channel X, such as by selecting channel X via an on-screen television guide. Instead of providing the program content corresponding to channel X, the television of Customer_{—}1 may present a message indicating that channel X is not currently active. The message may also give the customer an option to activate channel X (“Channel X is not currently active. Activate (no cost)?”). In response to Customer_{—}2 choosing to activate channel X, the content provider may automatically activate channel X for Customer_{—}2 (“Activate Channel X Based on User Instruction”). The activation process may be a relatively fast (e.g., on the order of minutes or seconds), thus allowing Customer_{—}2 to begin viewing channel X with minimum inconvenience.

By selectively activating and/or deactivating content for particular customers, a content provider, at any particular time, may maintain a set of active customers, for particular content, that corresponds to customers that are interested in the content. The techniques described herein may be particularly useful for content providers that are under a contractual obligation, with a content producer associated with content, to compensate the content producer based on the number of customers for which the content is active.

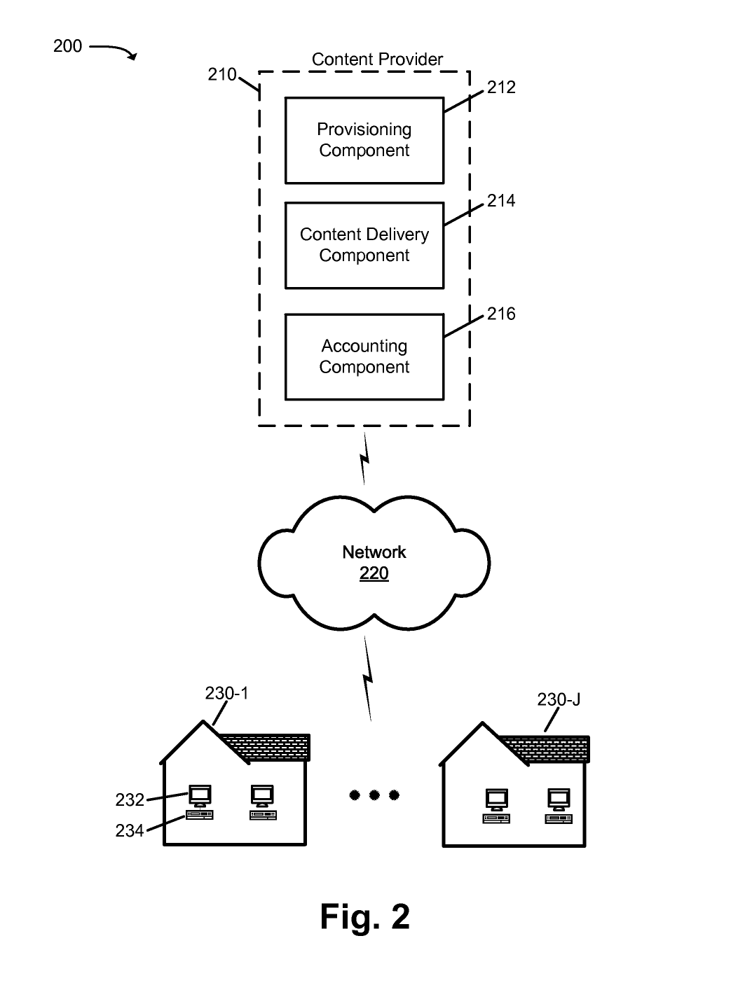

FIG. 2 is a diagram of an example environment 200, in which systems and/or methods described herein may be implemented. As shown in FIG. 2, environment 200 may include content provider 210, network 220, and user premises 230-1 through 230-J (where J is an integer greater than or equal to one). Content provider 210 may represent any entity that provides content to user premises 230. Content provider 210 may include, for example, one or more devices associated with a telecommunications company, a cable television provider, a satellite television provider, a television provider that provides television content over fiber optic cables, or another entity. As illustrated, content provider 210 may include, as illustrated, provisioning component 212, content delivery component 214, and accounting component 216. Provisioning component 212, content delivery component 214, and accounting component 216 are used herein to conceptually illustrate functionality associated with content provider 210 and do not necessarily represent individual devices.

Provisioning component 212 may operate to provision devices, associated with content provider 210 and/or user premises 230, to receive content. For television, various user premises 230 may be subscribed to various television packages. For example, a “basic” package may include access to a relatively few number of television stations. On the other hand, an “ultimate” package may include access to a large number of television stations. Some television stations may be available as part of a package or on an individual basis. For example, a customer that subscribes to a basic package, and who wishes to view a specific television channel that is not part of the basic package, may be given the option to individually add the specific television channel. Provisioning component 212 may configure devices, associated with content provider 210, such as content delivery component 214, to only provide authorized content to various user premises 230. Alternatively or additionally, provisioning component 212 may configure devices associated with user premises 230, such as set-top boxes, to control access to content.

Content delivery component 214 may include one or more devices, such as content servers, to provide content to user premises 230. For example, content delivery component 214 may receive content (e.g., television channels) from various content producers and provide the content to user premises 230. In some implementations, content delivery component 214 may control the providing of advertisements with the content and/or may provide other services associated with the content. As one example of a service associated with television content, content delivery component 214 may provide an interactive programming guide that provides customers with a list of television shows that are being broadcast and that will be broadcast in the near future.

Accounting component 216 may include one or more devices to provide accounting, logging, and/or statistics monitoring relating to the providing of content to user premises 230. For example, accounting component 216 may keep track of the current services and/or content subscribed to by each user premises 230 and/or video-on-demand content that has been ordered by each user premises 230. As described herein in additional detail, accounting component 216 may additionally monitor the usage of particular content, such as the usage/viewing of particular television channels.

Network 220 may include one or more wired and/or wireless networks. For example, network 220 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, network 240 may include a local area network (LAN), a wireless LAN (WLAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks. In one particular implementation, network 220 may be a network used to provide television content to user premises 230.

Each of user premises 230 may include one or more content viewing devices, illustrated as television 232 and set-top box (STB) 234. STB 234 may include one or more devices to receive television signals, decode the television signals, and provide the television signals to television 232. STB 234 may include other capabilities or services, such as the ability to act as a digital video recorder, a media hub, a media server, etc. STB 234 may, in response to a request from a user of STB 234, provide an interactive television programming guide to the user. Although user premises 230 is illustrated as containing televisions 232 and STBs 234, user premises 230 may include other types of content viewing/display devices, such as tablet computers, desktop computers, or other devices that may provide content, such as television channels, to users associated with user premises 230.

The quantity of devices and/or networks in environment is not limited to what is shown in FIG. 2. In practice, environment 200 may include additional devices and/or networks; fewer devices and/or networks; different devices and/or networks; or differently arranged devices and/or networks than illustrated in FIG. 2. Also, in some implementations, one or more of the devices of environment 200 may perform one or more functions described as being performed by another one or more of the devices of environment 200. Devices of environment 200 may interconnect via wired connections, wireless connections, or a combination of wired and wireless connections.

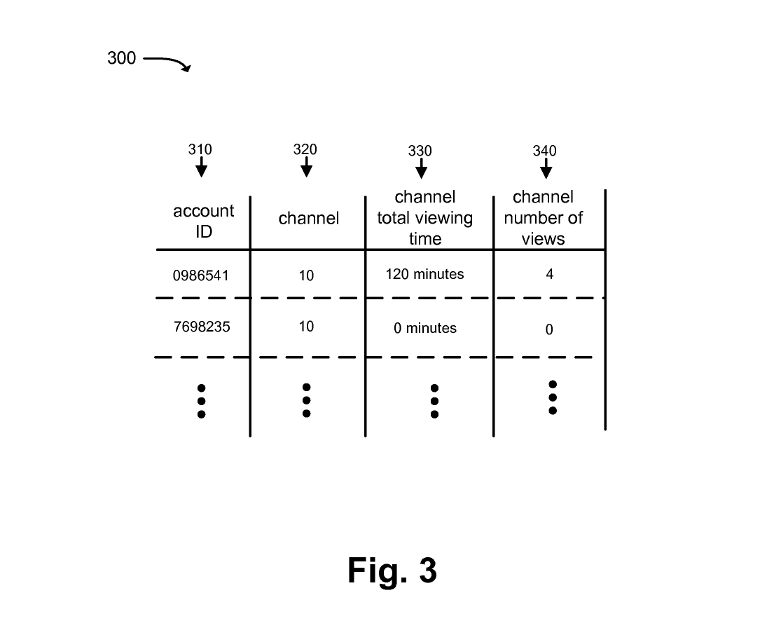

FIG. 3 is a diagram illustrating a data structure 300 that may be maintained by content provider 210, such as by accounting component 216. Data structure 300 may generally be used to store information relating to usage statistics of content viewed at user premises 230. In the example, of FIG. 3, the content may include television channels.

As illustrated, data structure 300 may include a number of fields, including: account identification (ID) field 310, channel field 320, channel total viewing time field 330, and channel number of views field 340. The fields shown for data structure 300 are examples. In alternative possible implementations, different, fewer, or additional fields may be implemented.

Account identification field 310 may store information that identifies particular accounts and/or user premises 230 of customers that receive television service. The identification information may include, for example, a user account name, an account number associated with a residence, a value uniquely associated with a STB, or other identification information.

Channel field 320 may include identifier associated with a particular channel for which usage information is to be monitored. Channel total viewing time field 330 may store the aggregate viewing time, corresponding to a particular channel and account identifier, over a test period. In general, a test period can be any length of time that may be useful to establish channel viewing habits of user premises 230. For example, a test period may be a week, multiple weeks, or a month. The test period may be determined based on billing periods or channel reporting periods that may be determined based on contractual obligations. Channel number of views field 340 may store a number of times, corresponding to the particular channel and account identifier, that the corresponding channel was tuned (i.e., selected for viewing by a STB at user premises 230).

Two example records are shown for data structure 300. Both records may correspond to usage statistics for channel 10 (channel field 320). As shown, the user premises associated with the account identifier “0986541” may have viewed channel 10 for a total of 120 minutes (channel total viewing time field 330) in four viewing sessions (channel number of views field 340). Similarly, the user premises associated with the account identifier “7698235” may not have viewed or tuned to channel 10 during the test period (i.e., channel total viewing time field 330 and channel number of views field 340 includes the value zero).

Although a channel total viewing time and the total number of channel views are illustrated as being tracked using the data structure 300, alternatively or additionally, additional information may be maintained, such as information specific to particular programs/shows that are watched and/or particular times or dates at which channels are watched.

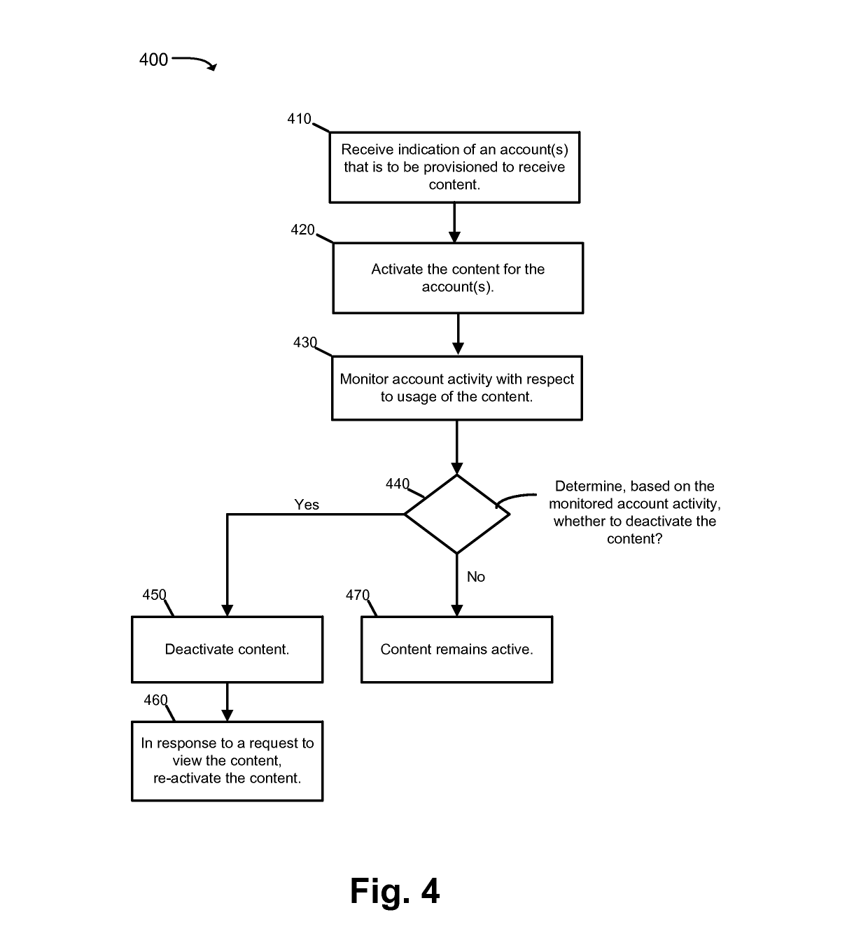

FIG. 4 is a flow chart illustrating an example process 400 for optimizing a set of customers for which content is active. Process 400 may be performed by, for example, content provider 210 and/or content provider 210 in conjunction with devices at user premises 230 (such as STBs 234).

Process 400 may include receiving an indication of an account(s) that is to be provisioned to receive content (block 410). As an example, a new customer may sign up with content provider 210 to receive television service. The customer may select a television package that includes one or more channels that content provider 210 would like to selectively activate based on whether the customer expresses an interest in the one or more channels. As another example, content provider 210 may decide that an existing television channel, which is currently active for a particular set of customer accounts, should be optimized to make the television channel active for only a subset of the accounts.

Process 400 may further include activating the content for the accounts (block 420). Activating the content for the accounts may include enabling the content to be immediately viewable when a customer chooses to view the content. For example, a customer that tunes or selects a television channel, such as via a STB 234, may immediately be provided with the television channel. In one implementation, provisioning component 212 may perform the activation of the content for any of the accounts for which the content is not currently active. Provisioning component 212 may, for example, communicate with content delivery component 214 and/or STBs 234 to make the content active.

Process 400 may further include, for the indicated account or accounts, monitoring account activity with respect to usage of the content (block 430). For example, for a particular television channel, viewing of the television channel may be monitored to determine the number of times the customer tunes STB 234 to the channel and/or the total amount of time that the customer views the channel. The monitoring may be performed over a particular time period, such as a week, a month, or another time period. The monitoring performed in block 420 may generally be used to determine the level of interest, expressed by the customer, in the content.

In one implementation of block 420, STBs 234, at user premises 230, may periodically or occasionally transmit usage statistics, relating to a channel viewed at user premises 230, to accounting component 216 of content provider 210. Accounting component 216 may store user statistics in a data structure, such as data structure 300. In other implementations, other techniques can be used to monitor account activity with respect to the usage of content. For example, when content is provided, via an application executing on a mobile device (e.g., a tablet or smart phone), the application may transmit usage statistics to accounting component 216.

In some implementations, information other than usage statistics may be monitored or otherwise obtained. For example, information explicitly obtained from a customer, such as information obtained from a questionnaire relating to the customer's interests, may be obtained and used when determining whether to activate content for a particular customer.

Process 400 may further include determining, based on the monitored account activity, whether to deactivate the content (block 440). As previously mentioned, the determination of whether to deactivate the content may include determining to deactivate the content for accounts that have not demonstrated an interest in the content. For example, in one implementation, content provider 210 may determine to deactivate the content for customers for which, over a monitored time period, the customers have viewed a particular content less than a threshold number of times (e.g., less than one). Another example, content provider 210 may determine to deactivate the content associated with customers for which, over the monitored time period, the content has been viewed fewer than a threshold number of times (e.g., two) or for which the total viewing time is less than a particular amount of time (e.g., 10 minutes). It can be appreciated that a number of different algorithms/techniques can be used to determine whether to deactivate content based on the monitored account activity or based on other information relating to an account/customer.

Process 400 may further include, when it is determined to deactivate the content (block 440—Yes), deactivating in the content (block 450). Deactivating the content may include disabling the content from being immediately viewable when the customer chooses to view the content. For example, for a television channel, a customer that tunes or selects the television channel, such as via a STB 234, may be provided with a message indicating that the user needs to initiate an activation process in order to view the channel. In one implementation, provisioning component 212 may perform the deactivation of the content. Provisioning component 212 may, for example, communicate with content delivery component 214 and/or STBs 234 to deactivate the content.

Process 400 may further include, in response to a request from a user premises 230, associated with deactivated content, re-activating the content (block 460). Re-activating the content may be similar to activation of the content, as performed in block 420. Thus, re-activating the content for an account may include enabling the content to be immediately viewable. In one implementation, provisioning component 212 may perform the deactivation of the content by communicating with content delivery component 214 and/or STBs 234 to make the content active. The next time the user chooses to view the content, such as by directing STB 234 to display the content, the content may be immediately viewable. In some implementations, block 460 may additionally include performing a check to ensure that the account is eligible to be active for the content.

When there is no determination to deactivate the content (block 440—No), the content (e.g., the television channel) may remain active at user premises 230 (block 470).

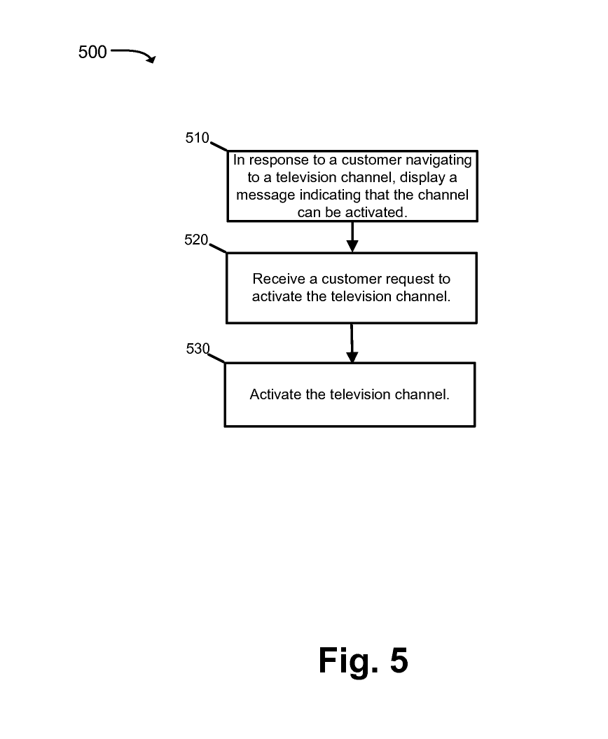

FIG. 5 is a flow chart illustrating an example process 500 for activating or re-activating a television channel. Process 500 may correspond to block 460 (FIG. 4) when the content, to be re-activated, includes a television channel. Process 500 may be performed by, for example, content provider 210 and/or content provider 210 in conjunction with devices at user premises 230 (such as STBs 234).

Process 500 may include, in response to a customer navigating to a particular television channel, displaying a message indicating that the customer may activate the television channel (block 510). For example, for a customer corresponding to a user premises 230 that is eligible to receive a television channel, when navigating to a particular television channel, instead of viewing the content of the television channel, the user may see a message such as “Great news, you are eligible to receive this channel at no additional cost; select ‘Activate’ to begin viewing the channel.” In one implementation, STBs 234 may be configured, such as by provisioning component 212, with a list of television channels that are deactivated but that may be automatically activated without charge. This list of television channels may correspond to the particular television channels for which the message is displayed.

Process 500 may further include receiving a customer request to activate the television channel (block 520). For example, in response to the user selecting “Activate” via STB 234, STB 234 may transmit a message to provisioning component 212 indicate that the television channel should be activated.

Process 500 may further include activating the television channel (block 530). As mentioned, activating the television channel may include provisioning the television channel to be immediately viewable when the user chooses to view the content. Provisioning component 212 may, for example, communicate with content delivery component 214 and/or STBs 234 to make the television channel active.

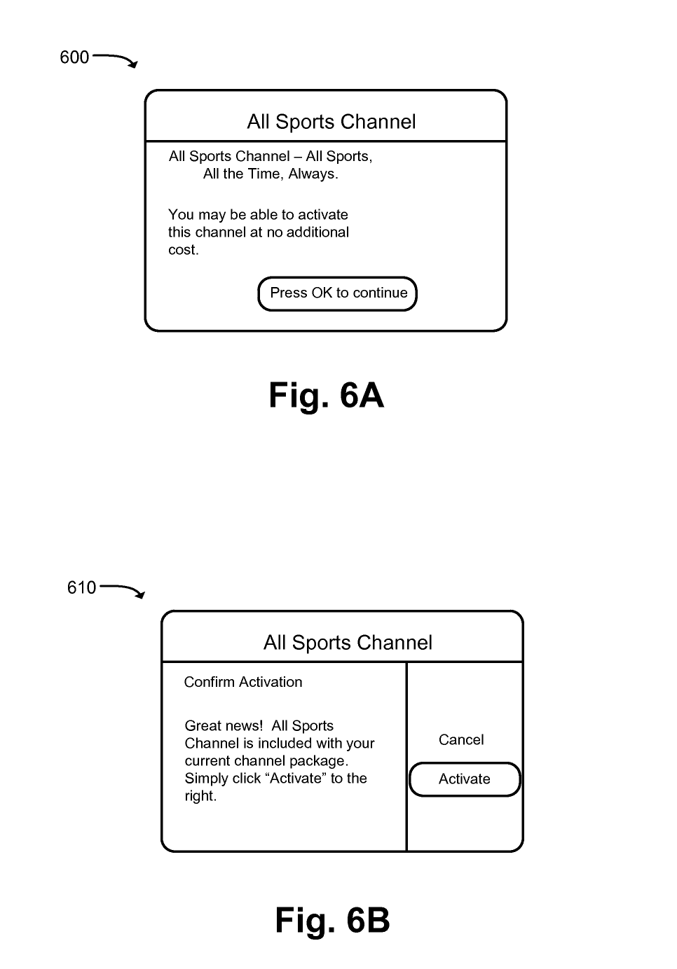

FIGS. 6A and 6B are diagrams illustrating example interfaces 600 and 610, respectively, that may be displayed to customers at user premises 230 when navigating to a television channel that is deactivated. Interfaces 600 and 610 may be provided by, for example, STB 234.

As shown in FIG. 6A, interface 600 may be presented to a customer when the customer attempts to view a particular television channel (“All Sports Channel”). In this example, assume that the account associated with the customer has been previously deactivated based on monitoring of the customers viewing habits with respect to the “All Sports Channel.” As illustrated, interface 600 may provide a message that the user may be able to activate the “All Sports Channel” (“You may be able to activate this channel at no additional cost”). The user may be prompted to press a particular button to continue with the activation (“Press OK to continue”).

As shown in FIG. 6B, interface 610 may be presented to the user in response to the user selecting “OK” in interface 600. Interface 610 may include a message confirming that the “All Sports Channel” is available for activation without any additional charges to the customer's account. As shown, the message may be: “Great news! All Sports Channel is included with your current channel package. Simply click ‘Activate’ to the right.” The user may be prompted to press a particular button to confirm the activation (“Activate”). In some implementations, before providing interface 610 to the user, STB 234 may query content provider 210 to confirm that the channel is available as part of the customer's current channel package.

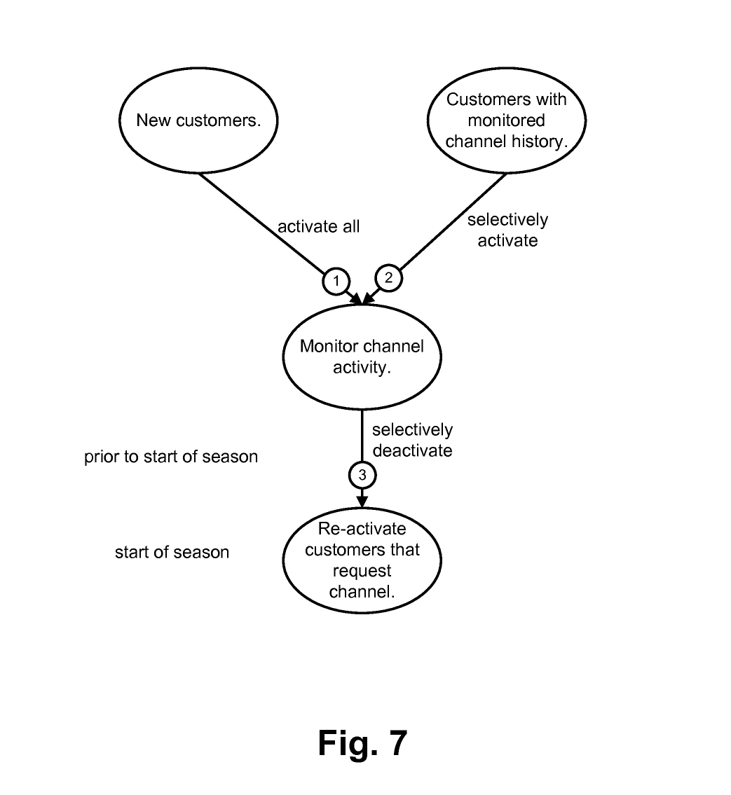

FIG. 7 is a flow diagram illustrating one example relating to distribution management of content using the techniques described previously. In this example, assume that the content is a television channel that provides sporting related content for a particular sport (e.g., basketball, football, hockey, etc.). The opening of the season, for the particular sport, may begin on a particular day and time, which may generate significant interest in the channel on the particular day and time. A content management technique that initially deactivates all customers associated with the television channel may result in significant customer dissatisfaction at the opening of the season, as the opening day of the season may result in a surge of activations which may overload the system, potentially resulting in long wait times before the television channel is activated for a particular customer. Accordingly, it may be desirable to selectively deactivate the television channel for only a subset of the customers.

Assume that the customers that are eligible to receive the television channel may be initially divided into a first set (“New customers”), about whom usage statistics relating to the television channel are unavailable, and the second set (“Customers with monitored channel history”) about which uses statistics relating to a television channel may be available. As illustrated in FIG. 7, the television channel for all of the new customers in the first set may be initially activated (arrow “1”, “activate all”). For the second set, however, the television channel may be selectively activated (e.g., the television channel may be deactivated for at least some of the customers in the second set) (arrow “2”, “selectively activate”). The deactivation may be performed, based on the usage statistics, as discussed above.

Prior to the start of the season, usage activity for the television channel may continue to be monitored (“Monitor channel activity”). As previously discussed, the monitoring may include collecting information such as number of times the television channel was viewed and/or the total amount of viewing time associated with the television channel. Based on the monitoring, and prior to the start of the season, the television channel may be additionally deactivated for one or more other customers (arrow “3”, “selectively deactivate”). In this manner, at the start of the season, customers who are likely to view the television channel may already have the television channel activated. Customers who are not likely or less likely to view television channel may have the television channel deactivated. For these customers, if they do decide to view television channel, television channel can be automatically reactivated, as discussed previously. Because the sets of customers for which the television channel is activated is intelligently determined based on the usage statistics, the set of customers who decide to re-activate the television channel on the opening day of the season may include a relatively small number of customers. The “re-activation load” may thus be relatively small and may not unduly burden provisioning component 212.

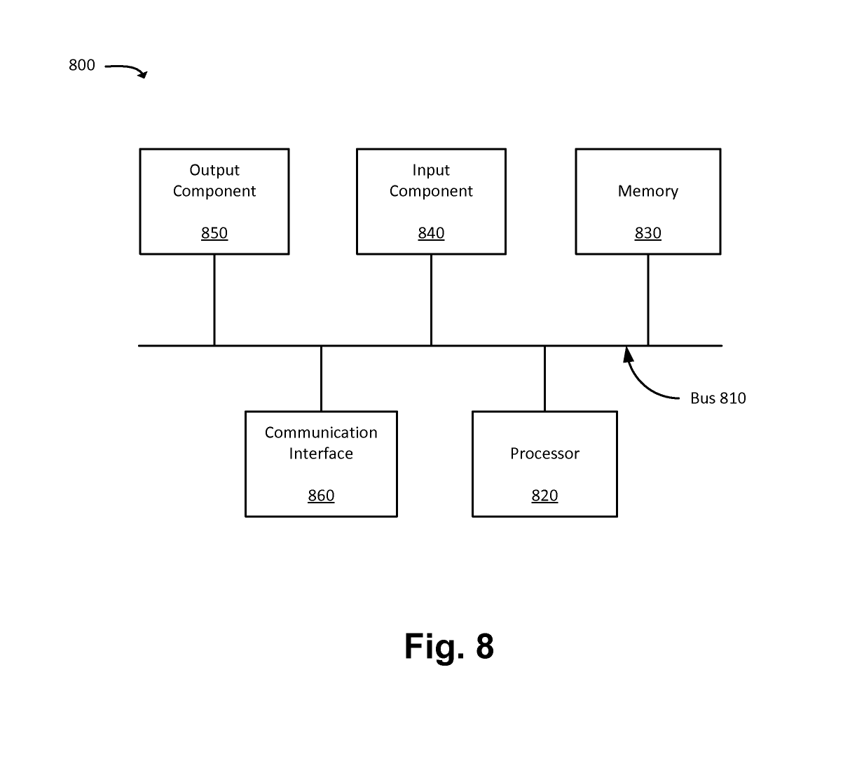

FIG. 8 is a diagram of example components of device 800. One or more of the devices described above (e.g., with respect to illustrated in FIGS. 1A, 1B, and/or 2) may include one or more devices 800. Device 800 may include bus 810, processor 820, memory 830, input component 840, output component 850, and communication interface 860. In another implementation, device 800 may include additional, fewer, different, or differently arranged components.

Bus 810 may include one or more communication paths that permit communication among the components of device 800. Processor 820 may include a processor, microprocessor, or processing logic that may interpret and execute instructions. Memory 830 may include any type of dynamic storage device that may store information and instructions for execution by processor 820, and/or any type of non-volatile storage device that may store information for use by processor 820.

Input component 840 may include a mechanism that permits an operator to input information to device 800, such as a keyboard, a keypad, a button, a switch, etc. Output component 850 may include a mechanism that outputs information to the operator, such as a display, a speaker, one or more light emitting diodes (LEDs), etc.

Communication interface 860 may include any transceiver-like mechanism that enables device 800 to communicate with other devices and/or systems. For example, communication interface 860 may include an Ethernet interface, an optical interface, a coaxial interface, or the like. Communication interface 860 may include a wireless communication device, such as an infrared (IR) receiver, a Bluetooth radio, or the like. The wireless communication device may be coupled to an external device, such as a remote control, a wireless keyboard, a mobile telephone, etc. In some embodiments, device 800 may include more than one communication interface 860. For instance, device 800 may include an optical interface and an Ethernet interface.

Device 800 may perform certain operations relating to one or more processes described above. Device 800 may perform these operations in response to processor 820 executing software instructions stored in a computer-readable medium, such as memory 830. A computer-readable medium may be defined as a non-transitory memory device. A memory device may include space within a single physical memory device or spread across multiple physical memory devices. The software instructions may be read into memory 830 from another computer-readable medium or from another device. The software instructions stored in memory 830 may cause processor 820 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations. For example, while series of blocks have been described with regard to FIGS. 4 and 5, the order of the blocks may be modified in other implementations. Further, non-dependent blocks may be performed in parallel.

Additionally, while an example data structure is illustrated in FIG. 3 as including certain types of information, in practice, these data structures may store additional, fewer, different, or differently arranged types of information than shown in these figures. Furthermore, while these data structures are shown as tables, in practice, these data structures may take the form of any other type of data structure, such as an array, a linked list, a hash table, a tree, and/or any other type of data structure.

The actual software code or specialized control hardware used to implement an embodiment is not limiting of the embodiment. Thus, the operation and behavior of the embodiment has been described without reference to the specific software code, it being understood that software and control hardware may be designed based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations are described herein in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A method comprising:
activating, by one or more devices, licensed content associated with a user premises;
obtaining, by the one or more devices, usage statistics relating to viewing of the licensed content associated with the user premises;
deactivating, by the one or more devices, the licensed content, the deactivation being performed based on an analysis of the usage statistics;
receiving a request, by the one or more devices, to activate the licensed content; and
automatically re-activating, by the one or more devices and in response to the received request, the licensed content.

2. The method of claim 1, further comprising:
providing, in response to a request to view the licensed content and when the licensed content is deactivated, a message indicating that the licensed content is available for activation on request.

3. The method of claim 2, wherein the message further indicates that the licensed content is available for activation at no additional cost to the user premises.

4. The method of claim 1, wherein the licensed content includes a television channel and wherein analysis of the usage statistics includes:
determining whether the television channel is a television channel that a user associated with the user premises is likely to view.

5. The method of claim 1, wherein the licensed content includes a television channel and wherein the usage statistics include:
a number of times that the television channel is viewed in a monitoring period; or
a total amount of time that the television channel is viewed in the monitoring period.

6. The method of claim 5, wherein the analysis of the usage statistics includes:
comparing the number of times that the television channel is viewed to a first threshold; or
comparing the total amount of time that the television channel is viewed to a second threshold.

7. The method of claim 1, wherein activating the licensed content includes:
initially provisioning the licensed content for the user premises when the licensed content is ordered as part of a package.

8. A system comprising:
a non-transitory memory device storing a set of computer-executable instructions; and
one or more processors configured to execute the computer-executable instructions, wherein executing the computer-executable instructions causes the one or more processors to:
activate licensed content associated with a user premises;
obtain usage statistics relating to viewing of the licensed content associated with the user premises;
deactivate the licensed content, the deactivation being performed based on an analysis of the usage statistics;
receive a request, from the user premises, to activate the licensed content; and
automatically re-activate, in response to the received request, the licensed content.

9. The system of claim 8, wherein executing the computer-executable instructions further causes the one or more processors to:
provide, in response to a request to view the licensed content and when the licensed content is deactivated, a message indicating that the licensed content is available for activation on request.

10. The system of claim 9, wherein the message further indicates that the licensed content is available for activation at no additional cost to the user premises.

11. The system of claim 8, wherein the licensed content includes a television channel and wherein executing the computer-executable instructions further causes the one or more processors to:
determine whether the television channel is a television channel that a user associated with the user premises is likely to view.

12. The system of claim 8, wherein the licensed content includes a television channel and wherein the usage statistics include:
a number of times that the television channel is viewed in a monitoring period; or
a total amount of time that the television channel is viewed in the monitoring period.

13. The system of claim 12, wherein the analysis of the usage statistics further includes executing the computer-executable instructions to cause the one or more processors to:
compare the number of times that the television channel is viewed to a first threshold; or
compare the total amount of time that the television channel is viewed to a second threshold.

14. The system of claim 8, wherein activating the licensed content further includes executing the computer-executable instructions to cause the one or more processors to:
initially provision the licensed content for the user premises as licensed content that is ordered as part of a package.

15. A system comprising:
a content provider to:
activate a licensed content channel associated with a user premises;
obtain usage statistics relating to viewing of the licensed content channel at the user premises, the usage statistics being obtained over a time period;
determine, after expiration of the time period, whether the licensed content channel is a channel that is likely to be watched by a user associated with the user premises; and
deactivate the licensed content channel when the determination indicates that the licensed content channel is not a channel that is likely to be watched by a user associated with the user premises; and
a set-top box to:
provide, when the user selects the licensed content channel and the licensed content channel is active, the licensed content channel for viewing; and
provide, when the user selects the licensed content channel and the licensed content channel is deactivated, a message indicating that the licensed content channel is available for activation on request.

16. The system of claim 15, wherein the message further indicates that the licensed content channel is available for activation at no additional cost to the user associated with the user premises.

17. The system of claim 15, wherein the usage statistics include:
a number of times that the licensed content channel is viewed during the time period.

18. The system of claim 15, wherein the usage statistics include:
a total amount of time that the licensed content channel is viewed during the time period.

19. The system of claim 15, wherein the content provider, when determining whether the licensed content channel is a channel that is likely to be watched by the user associated with the user premises, is further to:
compare the usage statistics to one or more thresholds to determine whether the licensed content channel was viewed a minimum amount during the time period.

20. The system of claim 15, wherein the licensed content channel is a sports related licensed content channel and wherein the time period is set to end before the beginning of a season for a particular sport associated with the licensed content channel.
